(19) United States
(12) Patent Application Publication
(10) Pub. No.: US 2019/0381456 A1
(43) Pub. Date: Dec. 19, 2019

(54) METHOD FOR MANAGING OPERATION OF REVERSE OSMOSIS MEMBRANE DEVICE AND REVERSE OSMOSIS MEMBRANE TREATMENT SYSTEM

(71) Applicant: KURITA WATER INDUSTRIES LTD., Tokyo (JP)

(72) Inventors: Hidekuni KAMEDA, Tokyo (JP); Hideyuki KOMORI, Tokyo (JP)

(21) Appl. No.: 16/489,173

(22) PCT Filed: Sep. 8, 2017
(86) PCT No.: PCT/JP2017/032490

§ 371 Date: Aug. 27, 2019

(30) Foreign Application Priority Data
Mar. 7, 2017 (JP) 2017-043002

(51) Int. Cl. B01D 61/12; B01D 65/02; B01D 61/02; B01D 61/08; B01D 65/08; C02F 1/00; C02F 1/44

(52) U.S. Cl. CPC B01D 61/12; B01D 65/02; B01D 61/025; B01D 61/08; B01D 65/08; C02F 2101/203; C02F 1/441; B01D 2311/10; B01D 2311/14; B01D 2311/246; C02F 1/008

(57) ABSTRACT

A method for managing an operation of a reverse osmosis membrane device, includes managing the operation of the reverse osmosis membrane device based on an aluminum ion concentration and/or an iron ion concentration of a feed water and/or a concentrated water of the reverse osmosis membrane device. Any one or more of suitability of a raw water as the feed water, a water temperature of the feed water, a concentration ratio (recovery rate), a pressure (feed water supply pressure, concentrated water pressure, or treated water pressure of the reverse osmosis membrane), an amount of the concentrated water, a continuous operation period, a washing time, a wash frequency, and a timing of replacement of the reverse osmosis membrane are managed based on the aluminum ion concentration and/or the iron ion concentration of the feed water and/or the concentrated water.

### TECHNICAL FIELD

The present invention relates to a method for managing an operation of a reverse osmosis membrane device and a reverse osmosis membrane treatment system which can continue a stable operation for a long time in the reverse osmosis membrane device even under a condition of a low water temperature (for example, a water temperature of 5 to 10° C.). In the present invention, “reverse osmosis membrane” means “reverse osmosis membrane” in a broad sense that encompasses “reverse osmosis membrane” and “nanofiltration membrane”.

### BACKGROUND ART

A reverse osmosis membrane including a surface dense layer and a porous support layer and passing a solvent molecule but no solute molecule enabled single stage desalination of seawater. Since then, the reverse osmosis membrane has been utilized in wider fields and after development of a low-pressure reverse osmosis membrane capable of being operated under low pressure, the reverse osmosis membrane has been utilized in purification of secondary treated sewage water, industrial wastewater, river water, lake water, leachate from landfill and the like.

Because the reverse osmosis membrane has a high rejection rate of a solute, permeated water obtained by a reverse osmosis membrane treatment has a good water quality and thus it can be effectively utilized in various applications. Proper management of the water quality of a feed water and an operation method for a reverse osmosis membrane device is important because continued operation of the reverse osmosis membrane device gradually reduces the amount of treated water. In particular, under a condition of a low water temperature, a scale made mainly of silica is likely to be generated and reduction of a flux due to a silica scale on the membrane surface is problematic.

For example, when tap water is used as a raw water, the silica concentration of the feed water is about 10 to 20 mg/L, whereas the solubility of silica (at equilibrium) under a low water temperature, particularly under a condition of a water temperature of 5° C. is as low as 20 mg/L, which makes the concentration with the reverse osmosis membrane difficult.

In the reverse osmosis membrane device, even when the operation is conducted so that the condition of less than the saturation solubility of silica is reached, a silica scale may be generated on the membrane surface to reduce the flux.

Typically, pH adjustment of the feed water or use of a scale dispersant is conducted to address these problems. For example, a method for adding a scale dispersant to a feed water to adjust the pH of the feed water to about 5.5 is employed (PTL 1). Additionally, an operation method involving adding a scale dispersant to suppress the Langelier's index of the concentrated water to 0.3 or less, and the silica concentration of the concentrated water to 150 mg/L or less is employed (PTL 2 to 4).

However, when an excessive acid is added for pH adjustment, hydrogen carbonate ions and carbonate ions in the feed water become dissolved carbon dioxide, which then passes through the reverse osmosis membrane and thus may cause deterioration in the quality of treated water. The method using a scale dispersant has a risk of scale generation in a failure of chemical addition. For this method, chemical cost is an economic burden.

PTL 5 discloses a reverse osmosis membrane separation device that changes the circulation ratio in a reverse osmosis membrane permeation module according to the water quality of either the feed water or the concentrated water. PTL 5 discloses determining an intended wastewater flow rate Qd′ by measuring the silica concentration Cs of the feed water and comparing the silica solubility Ss determined from a detected temperature value with Cs, and inhibiting the precipitation of a silica-based scale by adjusting the flow rate to be this intended wastewater flow rate. PTL 5 has no description suggesting that the operation management is conducted based on the aluminum ion concentration and/or the iron ion concentration of the feed water or the concentrated water in the reverse osmosis membrane device.

PTL 6 discloses a method for inhibiting scale deposition on a reverse osmosis membrane element by controlling a unit for pH adjustment and a unit for recovery rate adjustment of the permeated water so that the Langelier's index and the silica concentration of the concentrated water are maintained within their respective certain numerical ranges. PTL 6 also has no description to suggest that the operation management is conducted based on the aluminum ion concentration and/or the iron ion concentration of the feed water or the concentrated water in the reverse osmosis membrane device.

PTL 7 discloses a method for inhibiting scale precipitation on the surface of the RO membrane and generation of fouling without using an agent, by calculating the allowable concentration ratio of silica in the concentrated water based on the silica solubility determined from the silica concentration of the feed water and a temperature value of the permeated water or the concentrated water, calculating the first wastewater flow rate value from the calculated value of this allowable concentration ratio and an intended flow rate value of the permeated water, and controlling a wastewater valve so that the actual amount of wastewater is the first wastewater flow rate value. PTL 7 also has no description suggesting that the operation management is conducted based on the aluminum ion concentration and/or the iron ion concentration of the feed water or the concentrated water in the reverse osmosis membrane device.

PTL 8 and 9 and NPL 1 disclose that the precipitation of a silica scale is promoted by the presence of an aluminum ion or an iron ion in a water to be treated, in a reverse osmosis membrane module. All of them only mention the influence of the aluminum ion and the iron ion each as a “coexisting ion” of silica, and they do not suggest the following technological thought of the present invention: the aluminum ion and the iron ion in the concentrated water in the reverse osmosis membrane device influence the reduction of the flux of the reverse osmosis membrane, as an independent index having no relation with silica.

PTL 1: JPH 09-206749 A

PTL 2: JP 5287908 B

PTL 3: JP 5757109 B

PTL 4: JP 5757110 B

PTL 5: JP 2014-188439 A

PTL 6: JP 2012-183473 A

PTL 7: JP 2013-154274 A

PTL 8: JP 10-128075 A

PTL 9: JP 2003-326259 A

NPL 1: S. Salvador Cob et al., “Silica and silicate precipitation as limiting factors in high-recovery reverse osmosis operations”, Journal of Membrane Science, Jul. 23, 2012, Vol.423-424, pp. 1-10

Because generation of a scale on the surface of the reverse osmosis membrane extremely reduces the amount of treated water, the feed water concentration and the operation method need to be set properly in order to realize a long-term stable operation. No technology that can be sufficiently satisfactory is conventionally provided.

### SUMMARY OF INVENTION

It is an object of the present invention to provide a method for managing an operation of a reverse osmosis membrane device and a reverse osmosis membrane treatment system which can inhibit generation of a silica scale in the reverse osmosis membrane device even under a condition of a low water temperature such as a water temperature of 5 to 10° C. without requiring pH adjustment or addition of a scale dispersant to continue a stable operation for a long time.

The inventors have conducted intensive studies on a mechanism of reduction of the flux of the reverse osmosis membrane and as a result, found that not only the silica scale, but also an aluminum ion or an iron ion in the water themselves have a large influence on the reduction of the flux of the reverse osmosis membrane. The inventors have elucidated that a proper management of a silica concentration of a feed water and/or a concentrated water, as well as an aluminum ion concentration and/or an iron ion concentration in a certain concentration range, as an independent index from silica, is important for long-term stability of the operation of the reverse osmosis membrane device.

The gist of the present invention is as follows.
[1] A method for managing an operation of a reverse osmosis membrane device, comprising managing the operation of the reverse osmosis membrane device based on an aluminum ion concentration and/or an iron ion concentration of a water to be introduced to the reverse osmosis membrane device (hereinafter referred to as a “feed water”) and/or a concentrated water of the reverse osmosis membrane device, in a treatment of a raw water with the reverse osmosis membrane device.
[2] The method for managing an operation of a reverse osmosis membrane device according to [1], comprising managing any one or more of suitability of the raw water as the feed water, a water temperature of the feed water, a concentration ratio (recovery rate), a pressure (feed water supply pressure, concentrated water pressure, or treated water pressure of the reverse osmosis membrane), an amount of the concentrated water, a continuous operation period, a washing time, a wash frequency, and a timing of replacement of the reverse osmosis membrane, based on the aluminum ion concentration and/or the iron ion concentration of the feed water and/or the concentrated water.
[3] The method for managing an operation of a reverse osmosis membrane device according to [1] or [2], comprising conducting the management based on a total concentration of an aluminum ion and an iron ion in the feed water and/or the concentrated water.
[4] The method for managing an operation of a reverse osmosis membrane device according to any one of [1] to [3], comprising setting the aluminum ion concentration and/or the iron ion concentration with any one or more of a desired continuous operation period, washing time, concentration ratio, and water quality of the feed water as an index.
[5] The method for managing an operation of a reverse osmosis membrane device according to any one of [1] to [4], comprising conducting the management so that the aluminum ion concentration is 0.2 mg/L or less, the iron ion concentration is 0.2 mg/L or less, and a total concentration of an aluminum ion and an iron ion is 0.2 mg/L or less, in the concentrated water.
[6] The method for managing an operation of a reverse osmosis membrane device according to any one of [1] to [5], comprising conducting the management based on the aluminum ion concentration and/or the iron ion concentration of the feed water and/or the concentrated water and a saturation solubility of silica alone.
[7] The method for managing an operation of a reverse osmosis membrane device according to [6], comprising conducting the management so that a silica concentration of the concentrated water is 80 mg/L or less.
[8] The method for managing an operation of a reverse osmosis membrane device according to any one of [1] to [6], wherein there are a period during which a water temperature of the feed water is 5 to 10° C. and a period during which the water temperature of the feed water is 10° C. or more, and
the management according to the method for managing an operation of a reverse osmosis membrane device and an operation management according to the silica concentration and/or a Langelier's index are conducted in combination, in the period during which the water temperature is 5 to 10° C.
[9] A reverse osmosis membrane treatment system comprising:
   a reverse osmosis membrane device subjecting a raw water to a reverse osmosis membrane treatment; and
   a measurement unit measuring an aluminum ion concentration and/or an iron ion concentration of a water to be introduced to the reverse osmosis membrane device (hereinafter, referred to as a “feed water”) and/or a concentrated water of the reverse osmosis membrane device.
[10] The reverse osmosis membrane treatment system according to [9], comprising a control unit managing any one or more of suitability of the raw water as the feed water, a water temperature of the feed water, a concentration ratio (recovery rate), a pressure (feed water supply pressure, concentrated water pressure, or treated water pressure of the reverse osmosis membrane), an amount of the concentrated water, a continuous operation period, a washing time, a wash frequency, and a timing of replacement of the reverse osmosis membrane, based on the aluminum ion concentration and/or the iron ion concentration measured by the measurement unit.
[11] The reverse osmosis membrane treatment system according to [10], wherein the control unit conducts the management based on a total concentration of an aluminum ion and an iron ion in the feed water and/or the concentrated water measured by the measurement unit.
[12] The reverse osmosis membrane treatment system according to [10] or [11], wherein the control unit conducts the management so that the aluminum ion concentration is 0.2 mg/L or less, the iron ion concentration is 0.2 mg/L or less, or the total concentration of the aluminum ion and the iron ion is 0.2 mg/L or less, in the concentrated water.
[13] The reverse osmosis membrane treatment system according to any one of [10] to [12], further comprising a unit measuring a silica concentration of the feed water and/or the concentrated water, wherein the control unit conducts the management based on a measurement value of the aluminum ion concentration and/or the iron ion concentration and a measurement value of a concentration based on a saturation solubility of silica alone.
[14] The reverse osmosis membrane treatment system according to [13], wherein the control unit conducts the management so that the silica concentration of the concentrated water is 80 mg/L or less.

### Advantageous Effects of Invention

According to the present invention, an operation management based on water quality requires neither pH adjustment nor addition of a scale dispersant and can continue an operation with a long-term stable flux in a reverse osmosis membrane device. According to the present invention, even when the feed water has a low temperature (for example, 5 to 10° C.), scale precipitation can be inhibited and the operation with high flux and stability is possible.

According to the present invention, for example, a continuous operation without washing is possible for at least 3 months or more that is a period in which a conversion flux becomes 70% of the initial value.

The case where a scale dispersant is used as in the conventional method has a risk of scale generation in a failure of chemical addition, but the present invention is addressable without using any scale dispersant, and such a problem is resolved.

### BRIEF DESCRIPTION OF DRAWINGS

FIG. 1 is a schematic flow diagram illustrating an embodiment of the reverse osmosis membrane treatment system of the present invention.

FIG. 2 is a graph showing the result of Example 3.

FIG. 3 is a graph showing the result of Example 4.

### DESCRIPTION OF EMBODIMENTS

Hereinafter, embodiments of the present invention will be described in detail.

### [Feed Water]

Example of a raw water to be treated with a reverse osmosis membrane in the present invention includes, but is not limited at all to, tap water, clarified industrial water, and well water.

Regarding water quality of the feed water in the reverse osmosis membrane, the feed water has conventionally been evaluated to conduct a long-term continuous operation by fouling index (FI) defined in JIS K3802, silt density index (SDI) defined in ASTM D4189, or MF value, that is devised as a more convenient evaluation method by Taniguchi (Desalination, vol.20, p. 353-364, 1977), and a pretreatment of the raw water is conducted, as needed, to make this value lower than a specified value. For example, to make the FI value or SDI value 3 to 4 or less, the raw water is pretreated, as needed, to clarify the feed water in some extent. It is preferred in the present invention that the pretreatment such as a clarification treatment be conducted, as needed, to make the FI value of the feed water 4 or less.

### [Configuration of Reverse Osmosis Membrane Treatment System]

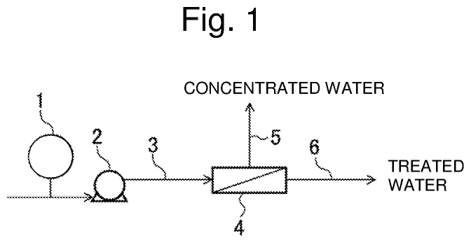

FIG. 1 is a schematic flow diagram illustrating an embodiment of the reverse osmosis membrane treatment system of the present invention. The raw water from a raw water tank (not shown) is introduced by a feed water pump, which is not shown, and a high-pressure pump for reverse osmosis membrane device 2, through a feed water pipe 3 into a reverse osmosis membrane device 4. Permeated water permeated the reverse osmosis membrane is discharged from a treated water pipe 6 and concentrated water is discharged from a concentrated water pipe 5.

The feed water pipe 3 is provided with a management instrument 1, which measures an aluminum ion concentration and/or an iron ion concentration of the feed water, then, operation management of the reverse osmosis membrane device is conducted based on this result.

The management instrument 1 may be provided on the concentrated water pipe 5 or may be provided on both the concentrated water pipe 5 and the feed water pipe 3. The feed water pipe 3 and/or the concentrated water pipe 5 may be provided with a management instrument that measures a silica concentration and/or a Langelier's index and conducts the operation management based on this value. The management instrument 1 may concurrently measure and control the silica concentration and/or the Langelier's index.

Basic operation conditions of the reverse osmosis membrane device are not particularly limited, but an amount of the concentrated water is 3.6 m³/hr or more. The conditions for an ultralow-pressure reverse osmosis membrane is a normal pressure of 0.735 MPa, a membrane area of 35 to 41 m², an initial pure water flux of 1.0 m/day (25° C.) or more, and an initial salt rejection rate of 98% or more. For reverse osmosis membrane, its rejection rate of an aluminum ion and an iron ion are not substantially changed and thus, any types of membrane can be used.

### [Operation Management of Reverse Osmosis Membrane Device]

In the present invention, the aluminum ion concentration and/or the iron ion concentration of the feed water and/or the concentrated water are measured and the operation of the reverse osmosis membrane device is managed based on this measurement value (hereinafter referred to as a “Al/Fe measurement value”). Operation management items thereof include any one or more of suitability of the raw water as the feed water, a water temperature of the feed water, a concentration ratio (recovery rate), a pressure (feed water supply pressure, concentrated water pressure, or treated water pressure of the reverse osmosis membrane), an amount of the concentrated water, a continuous operation period, a washing time, a wash frequency, and a timing of replacement of the reverse osmosis membrane. Specific example thereof includes a method for managing the following operation.
1) When the Al/Fe measurement value is the predetermined value or less, the raw water is introduced into the reverse osmosis membrane device as it is. When the Al/Fe measurement value is higher than the predetermined value, the raw water is determined as unsuitable as the feed water and feeding of the raw water to the reverse osmosis membrane is stopped. Alternatively, the raw water is subjected to a treatment for reducing the aluminum ion concentration and/or the iron ion concentration of the raw water to make the Al/Fe measurement value to the predetermined value or less, such as a deferrization/demanganization treatment or an ion exchange treatment, and then, introduced into the reverse osmosis membrane device. When a coagulation treatment is conducted with PAC or salt irons on the upstream side, PAC or salt irons affect the washing cycle and thus coagulation conditions are preferable to be changed appropriately.
2) When the Al/Fe measurement value is the predetermined value or less, the operation is continued without any change. When the Al/Fe measurement value is higher than the predetermined value, the water temperature of the feed water is increased.
3) When the Al/Fe measurement value is higher than the predetermined value, the flux, the pressure, or the concentration ratio (recovery rate) is reduced. When the Al/Fe measurement value is lower than the predetermined value, the flux, the pressure, or the concentration ratio (recovery rate) is increased.
4) When the Al/Fe measurement value is higher than the predetermined value, the settings are as follows: the continuous operation period is reduced, the washing time is increased, the wash frequency is increased, and a timing of replacement of the reverse osmosis membrane is reduced (replacement frequency is reduced). When the Al/Fe measurement value is lower than the predetermined value, the settings are as follows: the continuous operation period is increased, the washing time is reduced, the wash frequency is reduced, and a timing of replacement of the reverse osmosis membrane is increased (replacement frequency is increased).

The predetermined value of the Al/Fe measurement value is appropriately set so that a desired stable operation can be conducted based on the specification or the other operation conditions of the reverse osmosis membrane device. For example, in both cases that the water temperature of the feed water is a low temperature (5 to 10° C.) and 10° C. or more, the Al/Fe measurement value of the concentrated water is appropriately determined to have an aluminum ion concentration within a range of 0.01 to 0.2 mg/L, an iron ion concentration within a range of 0.01 to 0.2 mg/L, and the total concentration of an aluminum ion and an iron ion within a range of 0.02 to 0.2 mg/L.

In the present invention, any of the continuous operation period of the concentrated water, the washing time, the concentration ratio, and the water temperature is set from the Al/Fe measurement value. These may be managed so that the Al/Fe measurement value of the concentrated water is the predetermined value or less.

For example, by managing the operation so that an aluminum ion concentration is 0.2 mg/L or less and preferably 0.15 mg/L or less, an iron ion concentration is 0.2 mg/L or less and preferably 0.15 mg/L or less, and the total concentration of the aluminum ion and the iron ion is 0.2 mg/L or less, preferably 0.15 mg/L or less, in the concentrated water, the operation can be continued, free of maintenance for a long time and without washing, even when the water temperature of the feed water is a low temperature of 5 to 10° C.

For example, as shown in Table 3 described below, by managing the concentrated water to have an aluminum ion concentration of 0.2 mg/L or less, an iron ion concentration of 0.2 mg/L or less, and a total concentration of the aluminum ion and the iron ion of 0.2 mg/L or less, the operation can be continued free of maintenance for 3 months or more. In order to manage the aluminum ion concentration or the iron ion concentration of the concentrated water, a management sensor may be provided on the concentrated water pipe. Based on the measurement value of the management sensor provided on the feed water pipe, the concentration ratio may be adjusted to be fallen within the above range.

The silica concentration of the feed water and/or the concentrated water may be used as a management index, in combination with the Al/Fe measurement value. In this case, the silica concentration of the concentrated water is preferably managed to be 80 mg/L or less and particularly preferably 60 mg/L or less.

The operation management based on the Al/Fe measurement value is effective in the total water temperature range of the feed water. When the water temperature of the feed water is lower than 10° C., other operation managements, such as an operation management based on the silica concentration of the concentrated water and/or the Langelier's index, are preferably conducted in combination.

When the water temperature of the feed water is 5 to 10° C., specific example of a method for managing operation includes, as follows, a method for determining the recovery rate from the silica concentration and a calcium hardness of the feed water or the concentrated water, or the aluminum ion concentration and the iron ion concentration of the concentrated water, and then selecting the lowest recovery rate in the recovery rates calculated based on each value.

First, the recovery rate is determined so that the silica concentration of the concentrated water is 80 mg/L or less, and preferably 60 mg/L or less. For example, when the silica concentration of the feed water is 20 mg/L, the recovery rate is about 70% considering the saturation solubility of silica alone.

In addition, the recovery rate is determined so that the Langelier's index of the concentrated water is 0 or less.

Further, the recovery rate is determined so that the aluminum ion concentration is 0.2 mg/L or less, the iron ion concentration is 0.2 mg/L or less, or the total concentration of them is 0.2 mg/L or less, in the concentrated water.

Conducting operation with the lowest recovery rate among the above 3 recovery rates enables the reduction of the flux to be suppressed and stable operation for a long period to be conducted. When the flux is 70% or less of the initial value, it is highly likely that the flux cannot be recovered by washing. However, conducting operation management based on the Al/Fe measurement value enables no chemical injection operation for 3 months until the flux is reduced to 70% or less of the initial value.

### [Flushing]

In the present invention, low pressure flushing is preferably conducted as follows, when the operation of the reverse osmosis membrane device is stopped.

The equilibrium concentration of silica at a water temperature of 5° C. is 20 mg/L. The polymerization rate of silica is low and the silica concentration of the concentrated water is acceptable up to 80 mg/L. However, directly stopping the operation of the device may cause the precipitation of silica in the concentrated water side, so the low-pressure flushing is performed.

The low-pressure flushing is conducted by stopping the high-pressure pump for reverse osmosis membrane device when the device is stopped, activating only the feed water pump, flowing the feed water at the following pressure and amount of water, and securing the time for this process:

Pressure: about 0.1 to 0.3 MPa

Amount of water: 3 times or more, for example, about 3 to 5 times of amount of water retained in reverse osmosis membrane vessel.

When the above low-pressure flushing is conducted in stopped operation, and subsequently, stopped operation of the device is continued for 5 hours or more, the low-pressure flushing is preferably conducted again.

### [Other Treatment]

Later stage of the reverse osmosis membrane device in the present invention may be provided with an electrical deionization device or an ion exchange device, which enables further treatment of the reverse osmosis membrane permeated water. Former stage of the reverse osmosis membrane device may be provided with a safety filter, and if the residual chlorine concentration of the raw water is high, the former stage of the reverse osmosis membrane device may be provided with a residual chlorine removing apparatus, such as an activated carbon tower.

### EXAMPLES

The present invention will be further described in detail with reference to the following Experimental Examples in place of Examples.

### Experimental Example 1

The reverse osmosis membrane device is operated according to the following conditions.

### <Test Conditions>

Raw water: water of Nogi-machi

Amount of treated water: 0.6 to 0.8 m/day

Reverse osmosis membrane: ultralow-pressure reverse osmosis membrane “ES-20” manufactured by Nitto Denko Corporation

Recovery rate: 75%

Water temperature of the feed water (inlet of reverse osmosis membrane): 5 to 8° C.

Silica concentration of feed water: about 16 mg/L

Run 1 was conducted with the water of Nogi-machi without addition of chemicals. In Run 2, magnesium chloride, ferric chloride, and aluminum chloride were respectively added to the water of Nogi-machi as an Mg source, a Fe source, and an Al source to be a predetermined concentration.

The concentration of each component in the feed water and the concentrated water in the reverse osmosis membrane device in Run 1 and 2 was examined and the concentration ratio of the component and the concentration ratio of the amount of water were determined. In addition, differential pressure rising rates were examined based on the differential pressures before and after the operation for 4 days. The results are shown in Table 1.

TABLE 1

| | | SiO₂ | | Ca | | Mg | | Fe | |
|---|---|---|---|---|---|---|---|---|---|
| | | | Concen- | | Concen- | | Concen- | | Concen- |
| | | Concen- | tration | Concen- | tration | Concen- | tration | Concen- | tration |
| | | tration | ratio | tration | ratio | tration | ratio | tration | ratio |
| | Sample | (mg/L) | (times) | (mg/L) | (times) | (mg/L) | (times) | (mg/L) | (times) |
| Run | Feed | 16.2 | 4.2 | 14.6 | 4.5 | 3.9 | 4.1 | 0.0004 | 5.2 |
| 1 | water | | | | | | | | |
| | Concen- | 68.0 | | 65.6 | | 15.8 | | 0.0021 | |
| | trated | | | | | | | | |
| | water | | | | | | | | |
| Run | Feed | 16.7 | 4.3 | 13.6 | 4.7 | 8.4 | 4.1 | 0.0065 | 0.7 |
| 2 | water | | | | | | | | |
| | Concen- | 71.6 | | 64.0 | | 34.8 | | 0.0043 | |
| | trated | | | | | | | | |
| | water | | | | | | | | |
| | | | | | | | | | Differ- |
| | | | | | | | | Amount | ential |
| | | | | Al | | Cl | TOC | of water | pressure |
| | | | | | Concen- | Concen- | Concen- | Concen- | rising |
| | | | | Concen- | tration | tration | tration | tration | rate |
| | | | | tration | ratio | ratio | ratio | ratio | (MPa/ |
| | | | Sample | (mg/L) | (times) | (times) | (times) | (times) | day) |
| | | Run | Feed | 0.0149 | 4.7 | 4.1 | 4.1 | 4.3 | 0 |
| | | 1 | water | | | | | | |
| | | | Concen- | 0.0693 | | | | | |
| | | | trated | | | | | | |
| | | | water | | | | | | |
| | | Run | Feed | 0.0307 | 4.3 | 4.2 | — | 4.2 | 0.013 |
| | | 2 | water | | | | | | |
| | | | Concen- | 0.1322 | | | | | |
| | | | trated | | | | | | |
| | | | water | | | | | | |

The followings are found from Table 1. In Run 2, a rising trend of the differential pressure is recognized. In Run 2, non-uniform material balance of Fe indicates that a blockage by the Fe component was caused on a surface of the reverse osmosis membrane. Al is also considered to be deposited on the membrane surface, because it has a large difference as compared with other coexisting ions.

Elemental analysis for the membrane surface deposits of the reverse osmosis membrane after operating in Run 2 was conducted, and the results were shown in Table 2. Table 2 shows that a large amount of Al and Fe are deposited in particular among coexisting ions.

TABLE 2

| | Mass | Number of atoms |
|---|---|---|
| Element | (%) | (%) |
| Mg | 0.21 | 0.15 |
| Al | 2.27 | 1.45 |
| Si | 4.86 | 2.98 |
| Ca | 0.9 | 0.39 |
| Fe | 3.08 | 0.95 |
| Others | 88.68 | 94.08 |
| Total | 100 | 100 |

### Experimental Example 2

The tap water from which residual chlorine was removed, containing 20 mg/L of silica and having a water temperature of 5° C. was used as the feed water in the reverse osmosis membrane device. Aluminum chloride and ferric chloride were respectively added thereto as an Al source and a Fe source to adjust a predetermined Al concentration and Fe concentration, and then the feed water was concentrated 3 times by using ultralow-pressure reverse osmosis membrane “ES-20” manufactured by Nitto Denko Corporation (concentrated water silica: 60 mg/L).

A condition of the Al concentration and the Fe concentration of the feed water was variously changed, and the Al concentration, the Fe concentration, and the total concentration of Fe and Al in the concentrated water obtained by reverse osmosis membrane treatment was obtained by calculation in each condition. An operation period until the converted flux determined by the reduction rate of flux was reduced to 70% of the initial value (hereinafter referred to as “70% operation continuable days”) was calculated in each condition. The results are summarized in Table 3. In Table 3, 70% operation continuable days are represented by months.

TABLE 3

| | | Example | | | | | | | Comparative Example | | |
|---|---|---|---|---|---|---|---|---|---|---|---|
| | | Condition | Condition | Condition | Condition | Condition | Condition | Condition | Condition | Condition | Condition |
| Item | Unit | 1 | 2 | 3 | 4 | 5 | 6 | 7 | 1 | 2 | 3 |
| Calculated value | mg/L | 0.02 | 0.04 | 0.03 | 0.1 | 0.04 | 0.16 | 0.3 | 0.6 | 0.1 | 0.4 |
| of Al | | | | | | | | | | | |
| Concentration of | | | | | | | | | | | |
| concentrated | | | | | | | | | | | |
| water | | | | | | | | | | | |
| Calculated value | mg/L | 0.04 | 0.02 | 0.1 | 0.03 | 0.16 | 0.04 | 0.7 | 0.4 | 0.9 | 0.8 |
| of Fe | | | | | | | | | | | |
| concentration of | | | | | | | | | | | |
| concentrated | | | | | | | | | | | |
| water | | | | | | | | | | | |
| Calculated value | mg/L | 0.06 | 0.06 | 0.13 | 0.13 | 0.2 | 0.2 | 1 | 1 | 1 | 1.2 |
| of Al + Fe | | | | | | | | | | | |
| concentration of | | | | | | | | | | | |
| concentrated | | | | | | | | | | | |
| water | | | | | | | | | | | |
| 70% operation | Months | 12 | 11 | 6 | 5.5 | 3 | 2.7 | 0.5 | 0.2 | 0.4 | 0.1 |
| continuable days | | | | | | | | | | | |

<Calculated value of concentrated water = feed water concentration × concentration ratio of the amount of water>

The following are found from Table 3. The 70% operation continuable days are depending on the Al concentration, the Fe concentration, and the total concentration of Al and Fe in the concentrated water. From conditions 1 and 2, conditions 3 and 4, and conditions 6 and 7 of Examples, it was found that the Al concentration has a greater influence on the operation continuable days than the Fe concentration.

From conditions 1 to 6 of Examples, conditions 1 to 3 of Comparative Examples, and condition 7 of Examples, it is obvious that setting the Al concentration to 0.2 mg/L or less (calculated value), the Fe concentration to 0.2 mg/L or less (calculated value), and the total concentration of Al and Fe to 0.2 mg/L or less (calculated value), in the concentrated water, enables stable operation of the reverse osmosis membrane for a long period.

The calculated results of the 70% operation continuable days from some numerical values graphically shown were shown in Table 3. By utilizing these results, the operation management can be conducted as follows.

For example, a relational expression between operation continuable days and the Al/Fe measurement value was determined from gradients of the graphically shown results and the Al/Fe measurement value is calculated by substituting the predetermined days as operation continuable days into this relational expression. Then, the concentration ratio (recovery rate) or the like is controlled so that the Al/Fe measurement value in the concentrated water is the calculated value.

Alternatively, by substituting the Al/Fe measurement value into the above relational expression and thereby determining 70% operation continuable days, the time for continuous operation can be set and a washing cycle can be predicted. It is also possible to calculate concentrating extent relative to the Al/Fe measurement value of the feed water.

In Table 3, the operation period until a mathematical formula flux reduced to 70% was evaluated, but the reduction from the initial flux is not limited to 70%. The reduction from the initial flux is appropriately determined so that the wash frequency and the operation under desired operation conditions can be continued.

### Experimental Example 3

An experiment was conducted to demonstrate that the aluminum ion and the iron ion in the concentrated water are not serving as coexisting ions for precipitating silica, but factors having an influence on the reduction of flux of the reverse osmosis membrane, independent from silica.

Ferric chloride and aluminum chloride were added to pure water to be the Al concentration and the Fe concentration shown in the following Table 4, thereby preparing a simulated feed water 1. In addition, ferric chloride, aluminum chloride, and silica were added to a pure water to prepare a simulated feed water 2 having the Al concentration, the Fe concentration, and the SiO₂ concentration shown in the following Table 4.

TABLE 4

| | Simulated feed | Simulated feed |
|---|---|---|
| | water 1 | water 2 |
| Al concentration (mg/L) | 0.19 | 0.19 |
| Fe concentration (mg/L) | 0.19 | 0.19 |
| SiO₂ concentration (mg/L) | 0 | 25 |

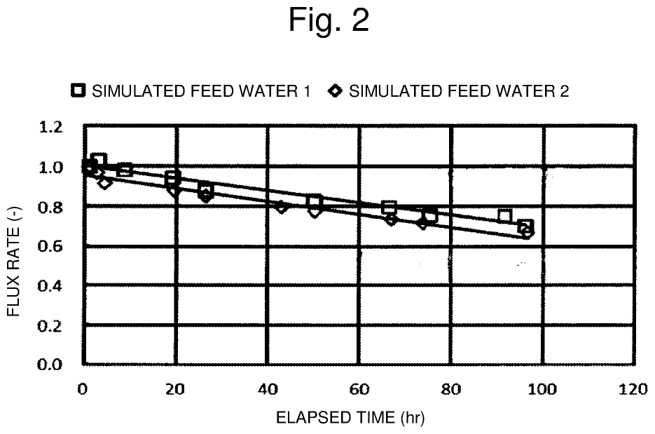

Each of the simulated feed water 1 and 2 was passed through the reverse osmosis membrane under the following test conditions and the changes of flux over time were examined. The results were shown in FIG. 2.

### <Test Conditions>

Reverse osmosis membrane: ultralow-pressure reverse osmosis membrane “ES-20” manufactured by Nitto Denko Corporation

Recovery rate: 80%

Water temperature of feed water (inlet of reverse osmosis membrane): 23° C.

Initial flux: 1.0 m/day

As obvious from FIG. 2, regardless of the presence or absence of silica in the feed water, the same concentration between the Al concentration and the Fe concentration of the feed water makes the reducing trend of flux equivalent. The followings were found from this result.

If the aluminum ion and the iron ion have influence as coexisting ions of silica, the simulated feed water 1 containing no silica and the simulated feed water 2 containing silica may not become the same reducing trend of flux. As obvious from the results of Experimental Example 3, the simulated feed water 1 containing no silica and the simulated feed water 2 containing silica have the same reducing trend of flux. This means that the aluminum ion and the iron ion are the index which should be controlled and managed independent from silica.

### Experimental Example 4

The relation to 70% operation continuable days at a water temperature of 5° C. or 25° C. was examined, in the same manner as Experimental Example 2, except that silica was further added to the feed water, the silica concentration, the Al concentration, and the Fe concentration of the feed water were changed, and the Al concentration, the Fe concentration, the total concentration of Fe and Al, and the silica concentration of the concentrated water obtained by reverse osmosis membrane treatment obtained by calculation were made to be the concentrations shown in Table 5. The results were shown in Table 5.

TABLE 5

| | | | | Comparative | |
|---|---|---|---|---|---|
| | | Example | | Example | |
| | | Condi- | Condi- | Condi- | Condi- |
| Item | Unit | tion 11 | tion 12 | tion 13 | tion 14 |
| Water temperature | ° C. | 5 | 25 | 5 | 25 |
| Calculated value | mg/L | 0.09 | 0.09 | 0.6 | 0.6 |
| of Al | | | | | |
| Concentration of | | | | | |
| concentrated water | | | | | |
| Calculated value | mg/L | 0.09 | 0.09 | 0.4 | 0.4 |
| of Fe | | | | | |
| concentration of | | | | | |
| concentrated water | | | | | |
| Calculated value | mg/L | 0.18 | 0.18 | 1.0 | 1.0 |
| of Al + Fe | | | | | |
| concentration of | | | | | |
| concentrated water | | | | | |
| Calculated value | mg/L | about | about | about | about |
| of silicacon | | 60 | 60 | 60 | 60 |
| centration of | | | | | |
| concentrated water | | | | | |
| Silica solubility | mg/L | about | about | about | about |
| | | 20 | 100 | 20 | 100 |
| 70% Operation | Months | 3 | 3 | 0.2 | 0.2 |
| continuable days | | | | | |

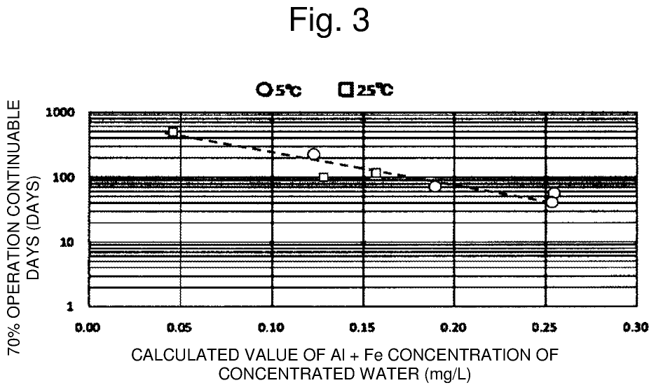

The total concentration of Fe and Al in the concentrated water was variously changed in the same way, and the relation between a calculated value of the Al+Fe concentration of the concentrated water and 70% operation continuable days was examined at 5° C. or 25° C. The results were shown in FIG. 3.

The followings are found from Table 5. Regardless of the water temperature, if the Al concentration and the Fe concentration are equivalent, 70% operation continuable days become equivalent. The Al concentration and the Fe concentration have an influence on 70% operation continuable days.

The followings are found from FIG. 3. The larger the total concentration of Fe and Al of the concentrated water is, the shorter 70% operation continuable days become. To make 70% operation continuable days 3 months or more, the Al+Fe concentration need to be 0.20 mg/L or less.

The present invention has been described in detail by using specific aspects and it is obvious to those skilled in the art that various modifications can be made without departing from the spirit and the scope and of the present invention.

The present application is based on JP 2017-043002 A filed on Mar. 7, 2017, all of which is incorporated herein by reference in its entirety.

### REFERENCE SIGNS LIST

1 management instrument

2 high pressure pump

3 feed water pipe

4 reverse osmosis membrane device

5 concentrated water pipe

6 treated water pipe

1. A method for managing an operation of a reverse osmosis membrane device, comprising managing the operation of the reverse osmosis membrane device based on an aluminum ion concentration and/or an iron ion concentration of a water to be introduced to the reverse osmosis membrane device (hereinafter referred to as a “feed water”) and/or a concentrated water of the reverse osmosis membrane device, in a treatment of a raw water with the reverse osmosis membrane device.

2. The method for managing an operation of a reverse osmosis membrane device according to claim 1, comprising managing any one or more of suitability of the raw water as the feed water, a water temperature of the feed water, a concentration ratio (recovery rate), a pressure (feed water supply pressure, concentrated water pressure, or treated water pressure of the reverse osmosis membrane), an amount of the concentrated water, a continuous operation period, a washing time, a wash frequency, and a timing of replacement of the reverse osmosis membrane, based on the aluminum ion concentration and/or the iron ion concentration of the feed water and/or the concentrated water.

3. The method for managing an operation of a reverse osmosis membrane device according to claim 1, comprising conducting the management based on a total concentration of an aluminum ion and an iron ion in the feed water and/or the concentrated water.

4. The method for managing an operation of a reverse osmosis membrane device according to claim 1, comprising setting the aluminum ion concentration and/or the iron ion concentration with any one or more of a desired continuous operation period, washing time, concentration ratio, and water quality of the feed water as an index.

5. The method for managing an operation of a reverse osmosis membrane device according to claim 1, comprising conducting the management so that the aluminum ion concentration is 0.2 mg/L or less, the iron ion concentration is 0.2 mg/L or less, and a total concentration of an aluminum ion and an iron ion is 0.2 mg/L or less, in the concentrated water.

6. The method for managing an operation of a reverse osmosis membrane device according to claim 1, comprising conducting the management based on the aluminum ion concentration and/or the iron ion concentration of the feed water and/or the concentrated water and a saturation solubility of silica alone.

7. The method for managing an operation of a reverse osmosis membrane device according to claim 6 comprising conducting the management so that a silica concentration of the concentrated water is 80 mg/L or less.

8. The method for managing an operation of a reverse osmosis membrane device according to claim 1, wherein there are a period during which a water temperature of the feed water is 5 to 10° C. and a period during which a water temperature of the feed water is 10° C. or more, and
the management according to the method for managing an operation of a reverse osmosis membrane device and an operation management according to a silica concentration and/or a Langelier's index are conducted in combination, in the period during which the water temperature is 5 to 10° C.

9. A reverse osmosis membrane treatment system comprising:
a reverse osmosis membrane device subjecting a raw water to a reverse osmosis membrane treatment; and
a measurement unit measuring an aluminum ion concentration and/or an iron ion concentration of a water to be introduced to the reverse osmosis membrane device (hereinafter, referred to as a “feed water”) and/or a concentrated water of the reverse osmosis membrane device.

10. The reverse osmosis membrane treatment system according to claim 9, comprising a control unit managing any one or more of suitability of the raw water as the feed water, a water temperature of the feed water, a concentration ratio (recovery rate), a pressure (feed water supply pressure, concentrated water pressure, or treated water pressure of the reverse osmosis membrane), an amount of the concentrated water, a continuous operation period, a washing time, a wash frequency, and a timing of replacement of the reverse osmosis membrane, based on the aluminum ion concentration and/or the iron ion concentration measured by the measurement unit.

11. The reverse osmosis membrane treatment system according to claim 10, wherein the control unit conducts the management based on a total concentration of an aluminum ion and an iron ion in the feed water and/or the concentrated water measured by the measurement unit.

12. The reverse osmosis membrane treatment system according to claim 10, wherein the control unit conducts the management so that the aluminum ion concentration is 0.2 mg/L or less, the iron ion concentration is 0.2 mg/L or less, or a total concentration of an aluminum ion and an iron ion is 0.2 mg/L or less, in the concentrated water.

13. The reverse osmosis membrane treatment system according to claim 10, further comprising a unit measuring a silica concentration of the feed water and/or the concentrated water,
wherein the control unit conducts the management based on a measurement value of the aluminum ion concentration and/or the iron ion concentration and a measurement value of a concentration based on a saturation solubility of silica alone.

14. The reverse osmosis membrane treatment system according to claim 13, wherein the control unit conducts the management so that the silica concentration of the concentrated water is 80 mg/L or less.
